(19) United States
(12) Patent Application Publication
(10) Pub. No.: US 2020/0019794 A1
(43) Pub. Date: Jan. 16, 2020

(54) A NEURAL NETWORK AND METHOD OF USING A NEURAL NETWORK TO DETECT OBJECTS IN AN ENVIRONMENT

(71) Applicant: Oxford University Innovation Limited, Oxford (GB)

(72) Inventors: Martin ENGELCKE, Oxford, Oxfordshire (GB); Dushyant RAO, Oxford, Oxfordshire (GB); Dominic Zeng WANG, Oxford, Oxfordshire (GB); Chi Hay TONG, Oxford, Oxfordshire (GB); Ingmar POSNER, Oxford, Oxfordshire (GB)

(21) Appl. No.: 16/334,815

(22) PCT Filed: Sep. 21, 2017
(86) PCT No.: PCT/GB2017/052817

§ 371 Date: Mar. 20, 2019

(30) Foreign Application Priority Data
Sep. 21, 2016 (GB) 1616095.4
Apr. 4, 2017 (GB) 1705404.0

(51) Int. Cl. G06K 9/00; G06K 9/62; G06N 3/04; G06N 3/08

(52) U.S. Cl. CPC G06K 9/00805; G06K 9/6249; G06N 3/08; G06N 3/04; G06K 9/00214

(57) ABSTRACT

A neural network comprising at least one layer containing a set of units having an input thereto and an output therefrom, the input being arranged to have data input thereto representing an n-dimensional grid comprising a plurality of cells; the set of units within the layer being arranged to output result data to a further layer the set of units within the layer being arranged to perform a convolution operation on the input data; and wherein the convolution operation is implemented using a feature centric voting scheme applied to the non-zero cells in the input to the layer.

This invention relates to a neural network and/or a method of using a neural network to detect objects in an environment. In particular, embodiments may provide a computationally efficient approach to detecting objects in 3D point clouds using convolutional neural networks natively in 3D.

3D point cloud data or other such data, representing a 3D environment, is ubiquitous in mobile robotics applications such as autonomous driving, where efficient and robust object detection is used for planning, decision making and the like. Recently, 2D computer vision has been exploring the use of convolutional neural networks (CNNs) For example, see the following publications:
Krizhevsky, I. Sutskever, and G. E. Hinton, “ImageNet Classification with Deep Convolutional Neural Networks,” Advances In Neural Information Processing Systems, pp. 1-9, 2012.
K. Simonyan and A. Zisserman, “Very deep convolutional networks for large-scale image recognition,” ICLR, pp. 1-14, 2015. [Online]. Available: http://arxiv.org/abs/1409.1556
C. Szegedy, W. Liu, Y. Jia, P. Sermanet, S. Reed, D. Anguelov, D. Erhan, V. Vanhoucke, and A. Rabinovich, “Going deeper with convolutions,” in Proceedings of the IEEE Computer Society Conference on Computer Vision and Pattern Recognition, vol. 07-12-June, 2015, pp. 1-9.
K. He, X. Zhang, S. Ren, and J. Sun, “Deep Residual Learning for Image Recognition,” arXiv preprint arXiv:1512.03385, vol. 7, no. 3, pp. 171-180, 2015. [Online]. Available: http://arxiv.org/pdf/1512.03385v1.pdf.

However, due to the computational burden introduced by the third spatial dimension, systems which process 3D point clouds, or other representations of 3D environments, have not yet experienced a comparable breakthrough when compared to 2D vision processing. Thus, in the prior art, the resulting increase in the size of the input and intermediate feature representations renders a naive transfer of CNNs from 2D vision applications to native 3D perception in point clouds infeasible for large-scale applications. As a result, previous approaches tend to convert the data into a 2D representation first, where spatially adjacent features are not necessarily close to each other in the physical 3D space, requiring models to recover these geometric relationships leading to poorer performance than may be desired.

The system described in D. Z. Wang and I. Posner, “Voting for Voting in Online Point Cloud Object Detection,” Robotics Science and Systems, 2015 achieves the current state of the art in both performance and processing speed for detecting cars, pedestrians and cyclists in point clouds on the object detection task from the popular KITTI Vision Benchmark Suite (A. Geiger, P. Lenz, and R. Urtasun, “Are we ready for autonomous driving? the KITTI vision benchmark suite,” in Proceedings of the IEEE Computer Society Conference on Computer Vision and Pattern Recognition, 2012, pp. 3354-3361).

A number of works have attempted to apply CNNs in the context of 3D point cloud data. A CNN-based approach by B. Li, T. Zhang, and T. Xia, “Vehicle Detection from 3D Lidar Using Fully Convolutional Network,” arXiv preprint arXiv:1608.07916, 2016 (Available: https://arxiv.org/abs/1608.07916 obtains comparable performance to the paper by Wang and Poser on KITTI for car detection by projecting the point cloud into a 2D depth map, with an additional channel for the height of a point from the ground. The model predicts detection scores and regresses to bounding boxes. While the CNN is a highly expressive model, the projection to a specific viewpoint discards information, which is particularly detrimental in crowded scenes. It also requires the network filters to learn local dependencies with regards to depth by brute force, information that is readily available in a 3D representation and which can be efficiently extracted with sparse convolutions.

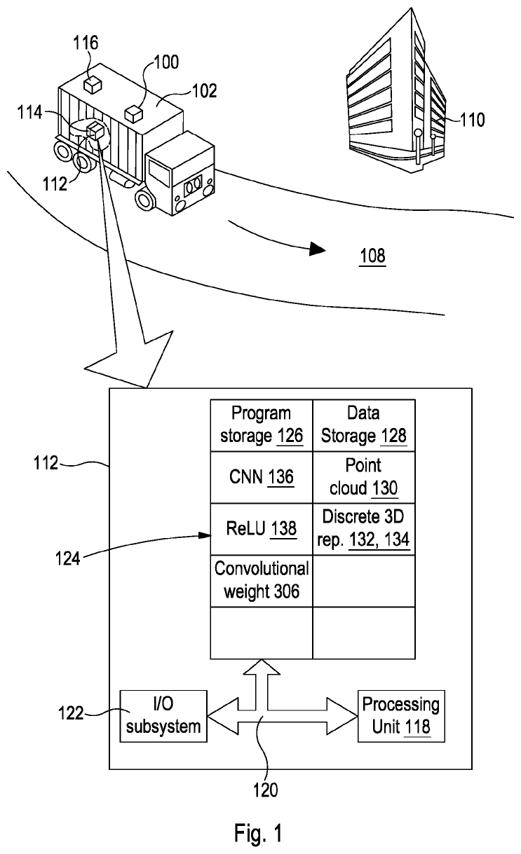

Dense 3D occupancy grids computed from point clouds are processed with CNNs in both D. Maturana and S. Scherer, “VoxNet: A 3D Convolutional Neural Network for Real-Time Object Recognition,” IROS, pp. 922-928, 2015 and 3D Convolutional Neural Networks for Landing Zone Detection from LiDAR,” International Conference on Robotics and Automation, no. FIG. 1, pp. 3471-3478, 2015. With a minimum cell size of 0.1 m, the first of these references, reports a speed of 6 ms on a GPU to classify a single crop with a grid-size of 32×32×32 cells. Similarly, a processing time of 5 ms per m3 for landing zone detection is reported in the second of these citations. With 3D point clouds often being larger than 60 m×60 m×5 m, this would result in a processing time of 60×60×5×5×10⁻³=90 s per frame, which does not comply with speed requirements typically encountered in robotics applications.

As another example, and referring to the Maturana and Scherer reference above, it takes up to 0.5 s to convert 200,000 points into an occupancy grid. When restricting point clouds from the KITTI dataset to the field of view of the camera, a total of 20,000 points are typically spread over 2×10⁶ grid cells with a resolution of 0.2 m as used in this work. Evaluating the classifier of the first of these two citations at all possible locations would therefore approximately take 6/8×10−3×2×10⁶=1500 s, while accounting for the reduction in resolution and ignoring speed ups from further parallelism on a GPU.

An alternative approach that takes advantage of sparse representations can be found in B. Graham, “Spatially-sparse convolutional neural networks,” arXiv Preprint arXiv:1409.6070, pp. 1-13, 2014 (Available: http://arxiv.org/abs/1409.6070) and “Sparse 3D convolutional neural networks,” arXiv preprint arXiv:1505.02890, pp. 1-10, 2015 (Available: http://arxiv.org/abs/1505.02890) which both apply sparse convolutions to relatively small 2D and 3D crops respectively. While the convolutional kernels are only applied at sparse feature locations, their algorithm still has to consider neighbouring values which are either zeros or constant biases, leading to unnecessary operations and memory consumption.

Another method for performing sparse convolutions is introduced in V. Jampani, M. Kiefel, and P. V. Gehler, “Learning Sparse High Dimensional Filters: Image Filtering, Dense CRFs and Bilateral Neural Networks,” in IEEE Conf. on Computer Vision and Pattern Recognition (CVPR), 2016. who use “permutohedral lattices” and bilateral filters with trainable parameters.

CNNs have also been applied to dense 3D data in biomedical image analysis (e.g. H. Chen, Q. Dou, L. Yu, and P.-A. Heng, “VoxResNet: Deep Voxelwise Residual Networks for Volumetric Brain Segmentation,” arXiv preprint arXiv:1608.05895, 2016 (Available: http://arxiv.org/abs/1608.05895); Q. Dou, H. Chen, L. Yu, L. Zhao, J. Qin, D. Wang, V. C. Mok, L. Shi, and P. A. Heng, “Automatic Detection of Cerebral Microbleeds From MR Images via 3D Convolutional Neural Networks,” IEEE Transactions on Medical Imaging, vol. 35, no. 5, pp. 1182-1195, 2016 (Available: http://ieeexplore.ieee.org); and A. Prasoon, K. Petersen, C. Igel, F. Lauze, E. Dam, and M. Nielsen, “Deep feature learning for knee cartilage segmentation using a triplanar convolutional neural network,” in Lecture Notes in Computer Science (including subseries Lecture Notes in Artificial Intelligence and Lecture Notes in Bioinformatics), vol. 8150 LNCS, no. PART 2, 2013, pp. 246-253.). A 3D equivalent of residual networks of K. He, X. Zhang, S. Ren, and J. Sun (above) is utilised in H. Chen, Q. Dou, L. Yu, and P. A. Heng for brain image segmentation. A cascaded model with two stages is proposed in Q. Dou, H. Chen, L. Yu, L. Zhao, J. Qin, D. Wang, V. C. Mok, L. Shi, and P. A. Heng for detecting cerebral microbleeds. A combination of three CNNs is suggested in [15] A. Prasoon, K. Petersen, C. Igel, F. Lauze, E. Dam, and M. Nielsen. Each CNN processes a different 2D image plane and the three streams are joined in the last layer. These systems run on relatively small inputs and in some cases take more than a minute for processing a single frame with GPU acceleration.

According to a first aspect of the invention there is provided a neural network comprising at least one of the following:
i. at least a first layer containing a set of units having an input thereto and an output therefrom,
ii. the input being arranged to have data input thereto representing a n-dimensional grid comprising a plurality of cells;
iii. the set of units within the first layer being arranged to output the result data to a further layer;
iv. the set of units with the layer being arranged to perform a convolution operation on the input data; and
v. wherein the convolutional operation is implemented using a feature centric voting scheme applied to non-zero cells in the input data.

Embodiments that provide such an aspect exploit the fact that the computational cost is proportional only to the number of occupied cells in an n-dimensional (for example a 3D grid) of data rather than the total number of cells in that n-dimensional grid. Thus, embodiments providing such an aspect may be thought of as providing a feature-centric voting algorithm leveraging the sparsity inherent in such n-dimensional grids. Accordingly, such embodiments are capable of processing, in real time, point clouds that are significantly larger than the prior art could process. For example, embodiments are able to process point clouds of substantially 40 m×40 m×5 m using current hardware and in real time.

Here real time is intended to mean such the point cloud can be processed such that a system can process the point cloud as it is generated. For example, in an embodiment where the point cloud is generated on an autonomous vehicle (such as a self-driving car) should be able to process that point cloud as the vehicles moves and to be able to make use of the data in the point cloud. As such, embodiments may be able to process the point cloud in substantially any of the following times: 100 ms, 200 ms, 300 ms, 400 ms, 500 ms, 750 ms, 1 second, or the like (or any number in between these times).

In some embodiments, the n-dimensional grid is a 3 dimensional grid, but the skilled person will appreciate that other dimensions, such as 4, 5, 6, 7, 8, 9 or more dimensions may be used.

Data representing a 3 dimensional environment may be considered as a 3 dimensional grid and may for instance be formed by a point cloud, or the like. In contrast to image data such representations of 3D environments encountered in mobile robotics (for example point clouds) are spatially sparse, as often most regions, or at least a significant proportion, are unoccupied.

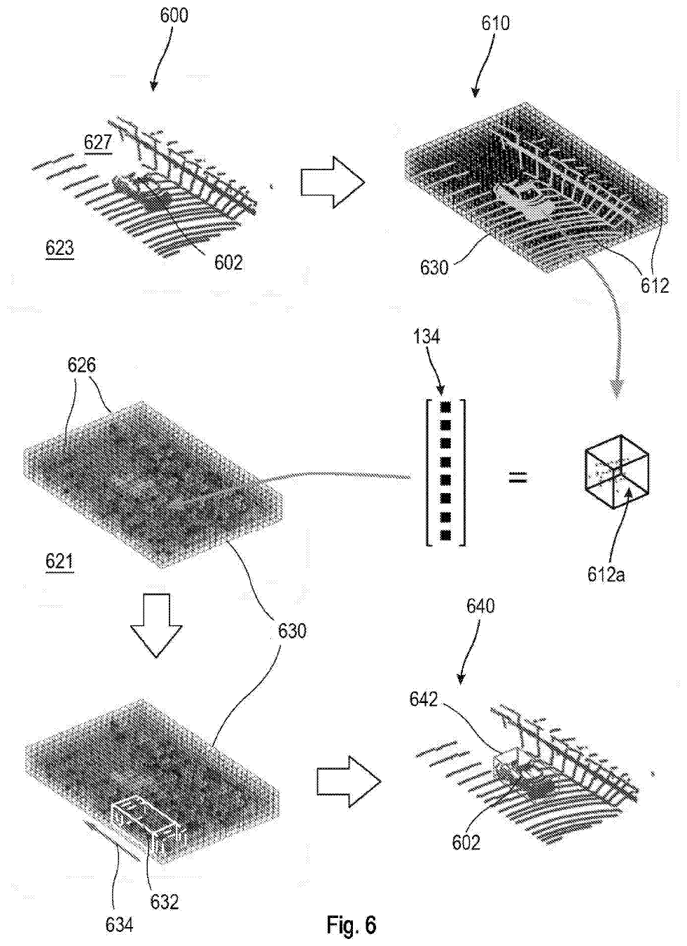

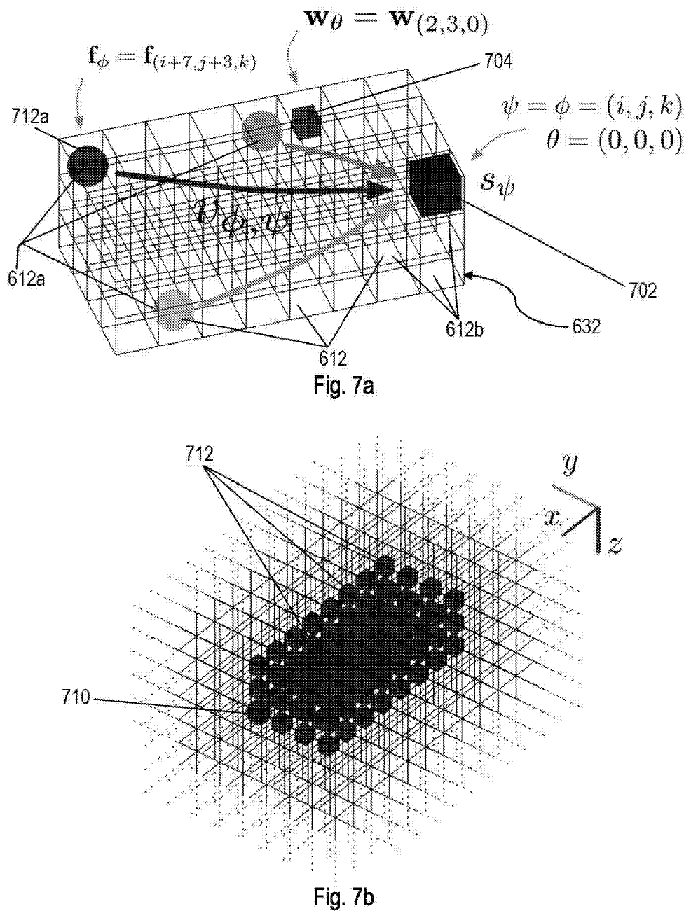

Typically, the feature centric voting scheme is as described in D. Z. Wang and I. Posner, “Voting for Voting in Online Point Cloud Object Detection,” Robotics Science and Systems, 2015. A proof that the voting scheme is equivalent to a dense convolution operation and demonstration of its effectiveness by discretising point clouds into 3D grids and performing exhaustive 3D sliding window detection with a linear Support Vector Machine (SVM) is show in this paper and a summary is provided below in relation to FIGS. 6 and 7.

Embodiments may therefore provide the construction of efficient convolutional layers as basic building blocks for neural network, and generally for Convolutional Neural Network (CNN) based point cloud processing by leveraging a voting mechanism exploiting the inherent sparsity in the input data.

Embodiments may also make use of rectified linear units (ReLUs) within the neural network.

Embodiments may also make use of an [symbol] ₁ sparsity penalty, within the neural network, which has the advantage of encouraging data sparsity in intermediate representations in order to exploit sparse convolution layers throughout the entire neural network stack.

According to a further aspect of the invention there is provided a method of detecting objects within a 3D environment.

According to a further aspect, there is provided a vehicle provided with processing circuitry, wherein the processing circuitry is arranged to provide at least one of the following:
i. a neural network comprising at least one layer containing a set of units having an input thereto and an output therefrom,
ii. the input being arranged to have data input thereto representing an n-dimensional grid comprising a plurality of cells;
iii. the set of units within the layer being arranged to output result data to a further layer
iv. the set of units within the layer being arranged to perform a convolution operation on the input data; and
v. wherein the convolution operation is implemented using a feature centric voting scheme applied to the non-zero cells in the input to the layer.

According to a further aspect of the invention, there is provided a machine readable medium containing instructions which, when read by a machine, cause that machine to provide the neural network of the first aspect of the invention or to provide the method of the second aspect of the invention.

Other aspects may provide a neural network comprising a plurality of layers being arranged to perform a convolution.

Other aspects may provide a neural network comprising at least a first layer containing a set of units having an input thereto and an output therefrom, the input may be arranged to have data input thereto representing an n-dimensional grid comprising a plurality of cells; the set of units within the first layer may be arranged to output result data to a further layer; the set of units with the first layer may be arranged to perform a convolution operation on the input data; and the convolution operation may be implemented using a feature centric voting scheme applied to the non-zero cells in the input data.

The machine-readable medium referred to may be any of the following: a CDROM; a DVD ROM/RAM (including -R/-RW or +R/+RW); a hard drive; a memory (including a USB drive; an SD card; a compact flash card or the like); a transmitted signal (including an Internet download, ftp file transfer of the like); a wire; etc.

Features described in relation to any of the above aspects, or of the embodiments, of the invention may be applied, mutatis mutandis, to any other aspects or embodiments of the invention.

There is now provided, by way of example only, a detailed description of one embodiment of the invention.

FIG. 1 shows an arrangement of the components of the embodiment being described;

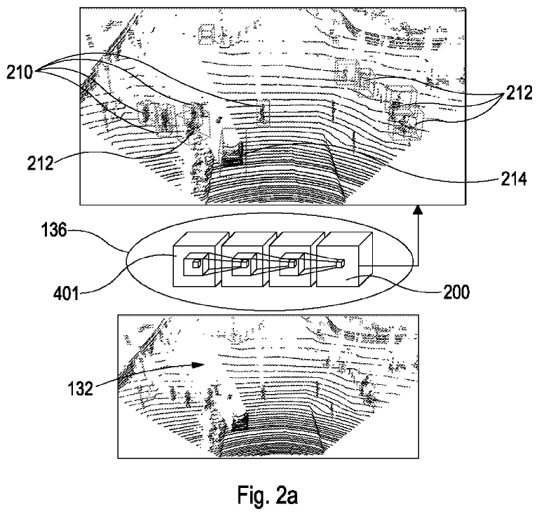

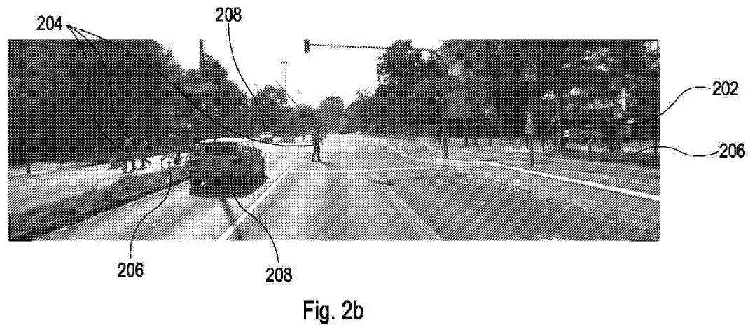

FIG. 2a shows the result obtained by applying the embodiment to a previously unseen point cloud from the KITTI dataset;

FIG. 2b shows a reference image of the scene that was processed to obtain the result shown in FIG. 2a;

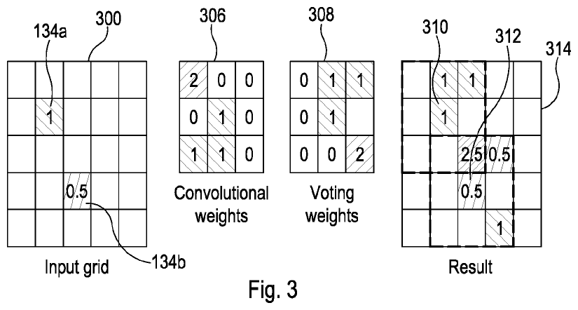

FIG. 3 illustrates a voting procedure on a 2D example sparse grid;

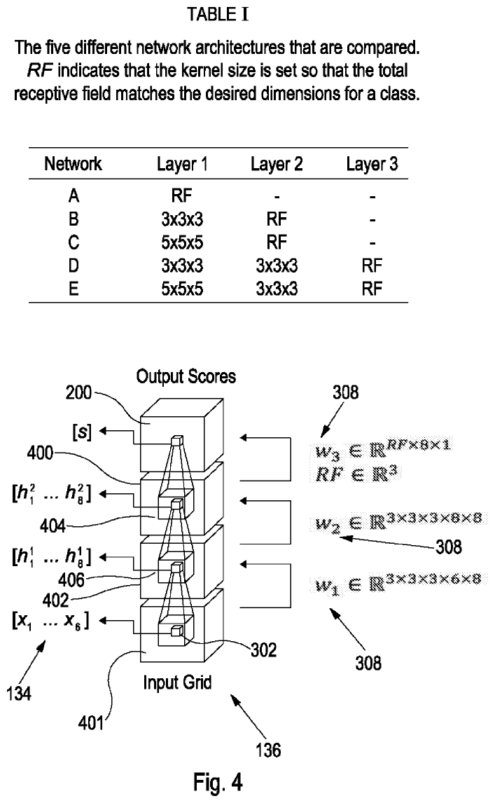

FIG. 4 illustrates a 3D network architecture from Table I;

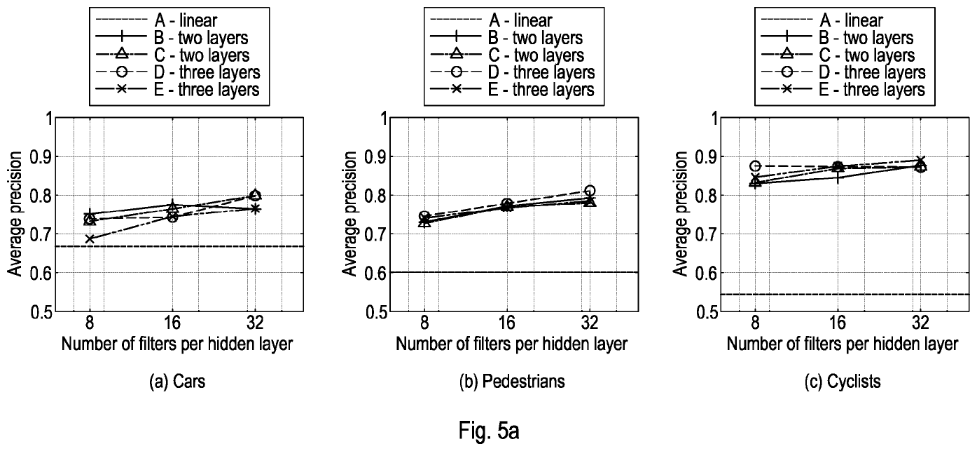

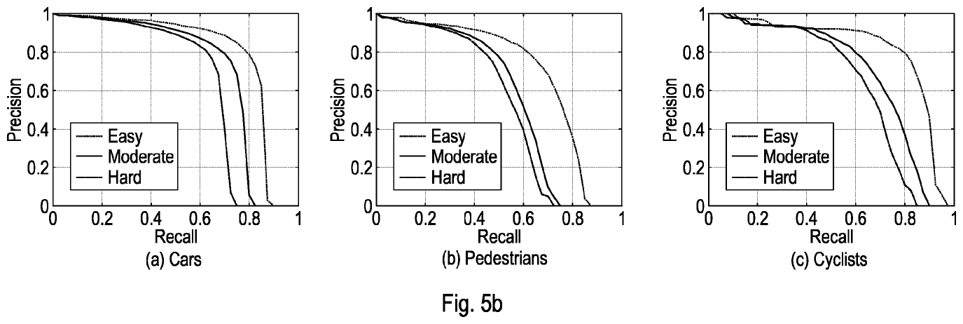

FIG. 5a shows comparative graphs for the architecture of Table I comparing results for Cars (a); Pedestrians (b) and Cyclists (c) using linear, two and three layer models;

FIG. 5b shows precision recall curves for the evaluation results on the KITTI test data set;

FIG. 6 (Prior Art) outlines a detection algorithm;

FIGS. 7a and 7b (Prior Art) provide further detail for FIG. 6; and

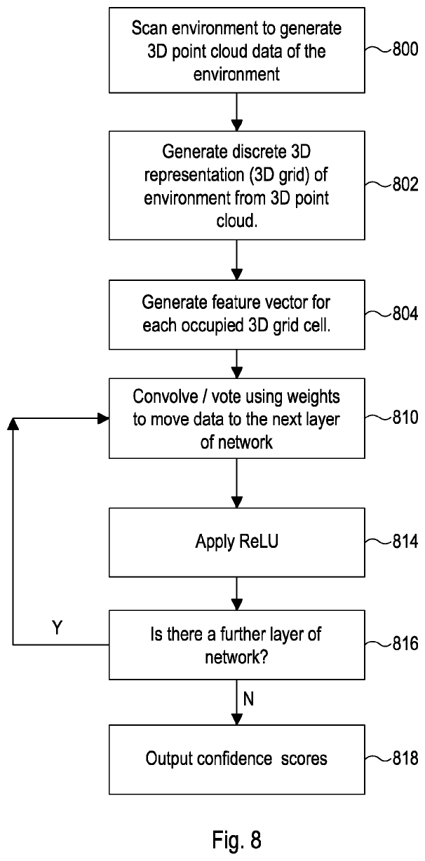

FIG. 8 shows a flow-chart outlining a method for providing an embodiment.

Embodiments of the invention are described in relation to a sensor 100 mounted upon a vehicle 102 highlighting how the embodiment being described may be implemented in a mobile vehicle and reference is made to FIG. 8 to help explain embodiments. The sensor 100 is arranged to monitor its locale and generate data based upon the monitoring thereby providing data on a sensed scene around the vehicle 102 (step 800). Here the sensed scene is a 3D (three dimensional) environment around the sensor 100/vehicle 102 and thus the captured data provides a representation of the 3D-evironment.

Here, it is convenient to describe the data in relation to a three dimensional environment and therefore to limit discussion to three dimensional data. However, in other embodiments other dimensions of data may be generated. Such embodiments may be in the field of urban transport, or embodiments may find utility in other, perhaps un-related, fields.

In the embodiment being described, the sensor 100 is a LIDAR (Light Detection And Ranging) sensor and emits light into the environment and measures the amount of reflected light from that beam in order to generate data on the sensed scene around the vehicle 100. The skilled person will appreciate other sensors may be used to generate data on the environment. For example, the sensor may be a camera, pair of cameras, or the like. For example any of the following arrangements may be suitable, but the skilled person will appreciate that there may be others: LiDAR; RADAR; SONAR; Push-Broom arrangement of sensors.

In the embodiment shown in FIG. 1, the vehicle 102 is travelling along a road 108 and the sensor 100 is imaging the locale (eg the building 110, road 108, etc.) as the vehicle 102 travels. In this embodiment, the vehicle 102 also comprises processing circuitry 112 arranged to capture data from the sensor and subsequently to process the data (in this case point cloud data) generated by the sensor 100 and representing the environment. In the embodiment being described, the processing circuitry 112 also comprises, or has access to, a storage device 114 on the vehicle.

Whilst it is convenient to refer to a 3D point cloud, point cloud, or the like, other embodiments may be applied to other representations of the 3D environment. As such, reference to point cloud below should be read as being a representation of a 3D environment.

The lower portion of the FIG. 1, shows components that may be found in a typical processing circuitry 112. A processing unit 118 may be provided which may be an Intel® X86 processor such as an I5, I7 processor or the like. The processing unit 118 is arranged to communicate, via a system bus 120, with an I/O subsystem 122 (and thereby with external networks, displays, and the like) and a memory 124.

The skilled person will appreciate that memory 124 may be provided by a variety of components including a volatile memory, a hard drive, a non-volatile memory, etc. Indeed, the memory 124 comprise a plurality of components under the control of the processing unit 118.

However, typically the memory 124 provides a program storage portion 126 arranged to store program code which when executed performs an action and a data storage portion 128 which can be used to store data either temporarily and/or permanently.

In the embodiment being described, and as described in more detail below, the program storage portion 126 implements three neural networks 136 each trained to recognise a different class of object, together with the Rectified Linear Units (ReLU) 138 and convolutional weights 306 used within those networks 136. The data storage portion 128 handles data including point cloud data 132; discrete 3D representations generated from the point cloud 132 together with feature vectors 134 generated from the point cloud and used to represent the 3D representation of the point cloud. The networks 136 are Convolutional Neural Networks (CNN's), but this need not be the case in other embodiments.

In other embodiments at least a portion of the processing circuitry 112 may be provided remotely from the vehicle. As such, it is conceivable that processing of the data generated by the sensor 100 is performed off the vehicle 102 or a partially on and partially off the vehicle 102. In embodiments in which the processing circuitry is provided both on and off the vehicle then a network connection (such as a 3G UMTS (Universal Mobile Telecommunication System), 4G LTE (Long Term Evolution) or WiFi (IEEE 802.11) or like).

It is convenient to refer to a vehicle travelling along a road but the skilled person will appreciate that embodiments of the invention need not be limited to land vehicles and could water borne vessels such as ships, boats or the like or indeed air borne vessels such as airplanes, or the like. Some embodiments may be provided remote from a vehicle and find utility in fields other than urban transport.

The embodiment being described performs efficient, when compared to the prior art, large-scale multi-instance object detection with a neural network (and in the embodiment being described in a Convolutional Neural Network CNNs) natively, typically in 3D point clouds.

A first step is to convert a point-cloud 132, such as captured by the sensor 100, to a discrete 3D representation. Initially, the point-cloud 132 is discretised into a 3D grid (step 802), such that for each cell that contains a non-zero number of points, a feature vector 134 is extracted based on the statistics of the points in the cell (step 804). The feature vector 134 holds a binary occupancy value, the mean and variance of the reflectance values and three shape factors. Other embodiments may store other data in the feature vector. Cells in empty space are not stored, as they contain no data, which leads to a sparse representation and an efficient use of storage space, such a memory 128.

An example of an image 202 of a typical environment in which a vehicle 102 may operate is shown in FIG. 2b. Within this image 202 there can be seen a number of pedestrians 204, cyclists 206 and a cars 208.

In the embodiment being described, the image 202 shown in FIG. 2a is not an input to the system and provided simply to show the urban environment encountered by mobile vehicles 102, such as that being described, and which was processed to generate the 3D representation of FIG. 2a. The sensor 100 is a LiDAR scanner and generates point cloud data of the locale around the vehicle 102.

The discrete 3D representation 132 shown in FIG. 2a is an example of a raw point cloud as output by the sensor 100. This raw point-cloud is then processed by the system as described herein.

In the embodiment being described, as is described hereinafter, the processing circuitry 112 is arranged to recognise three classes of object: pedestrians, cyclists and cars. This may be different in other embodiments.

The top most portion of FIG. 2a shows the processed point cloud after recognition by the neural network 136 and within the data, the recognised objects are highlighted: pedestrians 210; cyclists 212; and the car 214.

The embodiment being described employs the voting scheme from D. Z. Wang and I. Posner, “Voting for Voting in Online Point Cloud Object Detection,” Robotics Science and Systems, 2015. to perform a sparse convolution across this native 3D representation 132, followed by a ReLU (Rectified Linear Unit) 138 non-linearity, which returns a new sparse 3D representation—step 814. This reference is incorporated by reference and the skilled person is directed to read this reference. In particular, reference is made to the voting scheme and the skilled person is directed to read those sections in particular.

However, a brief summary of the voting scheme is as follows and is described with reference to FIGS. 6 and 7.

Below, a proof that sparse convolution is equivalent to the process of voting is presented.

The feature grid 630 is naturally four-dimensional—there is one feature vector 134 per cell 612, and cells 612 span a three-dimensional grid 610. The l'th feature at cell location (i, j, k) is denoted by flijk. Alternatively, it may be convenient to refer to all features computed at location (i, j, k) collectively as a vector fijk. To keep the presentation simple and clear, the tuple (i, j, k) is referred to by a single variable, ϕ=(i, j, k).

If the grid dimension is (NGx,NGy,NGz) then the set Φ=[0,Nₓ^{G})×[0,N_{y}^{G})×[0,N_{z}^{G}) is defined, thus ϕ∈Φ. Hence the notation [m,n) is to be understood as the standard half-open interval defined over the set of integers, i.e. [m; n)={q∈ [symbol] :m≤q<n} and “×” denotes the set Cartesian product.

In this notation, fijk can be written in the cleaner form fϕ (this indexing notation is illustrated in FIG. 7a). Recall that by definition fϕ=0 if the cell 712 at ϕ is not occupied. The concept can be captured by defining a subset Φ*⊂Φ that represents the subset of cell locations that are occupied. Thus ϕ∈Φ\Φ*⇒=f_{ϕ}=0. The feature grid 630 is sparse.

Similarly, if the dimensions of the detection window 632 is (NWx,NWy,NWz), the set Θ=[0,Nₓ^{W})×[0,N_{y}^{W})×[0,N_{z}^{W}) can be defined. The weights associated with location θ∈Θ are denoted as wθ (an example is also illustrated in FIG. 7a). In contrast to the feature grid 630, the weights can be dense.

Finally, and to remove boundary conditions, the feature vectors 134 and weight vectors are defined to be zero if their indices are outside the bounds. For example, wθ=0 if θ=(−1, 0, 0). This extends the set of indices in both cases (feature and weights) to the full [symbol] ³. The formalities are now arranged such that the proof may be derived as shown below.

Theorem 1:

“The detection score s_{ψ} for the detection window with origin placed at grid location ψ can be written as a sum of votes from occupied cells that fall within the detection window.”

Proof:

The explicit form for the detection score s_{ψ} according to the linear classifier is:

$${s}_{ψ} = {\sum }_{θ ∈ Θ} {f}_{ψ + θ} \cdot {w}_{θ} \qquad Eq . ( 1 )$$

where “·” denotes the vector dot product. Since w_{θ}=0, whenever θ∈Θ, the summation can be extended to the entire [symbol] ³. Then, after a change of variables, ϕ=ψ+θ:

$$\begin{matrix}{s}_{ψ} = {\sum }_{θ = {ℤ}^{3}} {f}_{ψ + θ} \cdot {w}_{θ} & Eq . ( 2 ) \\ = {\sum }_{Φ ∈ {ℤ}^{3}} {f}_{φ} \cdot {w}_{φ - ψ} & Eq . ( 3 ) \\ = {\sum }_{φ ∈ Φ} {f}_{φ} \cdot {w}_{φ - ψ} & Eq . ( 4 ) \\ = {\sum }_{φ ∈ {Φ}^{*}} {f}_{φ} \cdot {w}_{φ - ψ} & Eq . ( 5 )\end{matrix}$$

Equation 4 follows from Equation 3 because f_{ϕ}=0∀ϕ∉Φ, and Equation 5 then follows from Equation 4 because f_{ϕ}=0 for unoccupied cells (eg 612b) by definition.

Now, noting that w_{ϕ}=0∀θ∉Θ, this implies that the summation in Equation 5 reduces to:

$${s}_{ψ} = {\sum }_{φ ∈ Φ * ⋂ {Γ}_{ψ}} {f}_{φ} \cdot {w}_{φ - ψ} \qquad Eq . 6$$

where Γ_{ψ}{ϕ∈ [symbol] ³:ϕ−ψ∈Θ}={ϕ∈ [symbol] ³:∃θ∈Θ,ϕ=ψ+θ}.

If the vote from the occupied cell 612a at location ϕ to the window 632 at location ψ is defined as v_{ϕ,ψ}=f_{ϕ}·w_{ϕ-ψ}, Equation 6 becomes:

$${s}_{ψ} = {\sum }_{φ ∈ Φ * ⋂ {Γ}_{ψ}} {v}_{φ , ψ} \qquad Eq . ( 7 )$$

This completes the proof.

Theorem 1 gives a second view of detection on a sparse grid, in that each detection window 632 location is voted for by its contributing occupied cells 612a. Cell voting is illustrated in FIG. 3a. Indeed, votes being cast from each occupied cell 612a for different detection window 632 locations in support of the existence of an object of interest at those particular window locations can be pictured. This view of the voting process is summarised by the next corollary.

Corollary 1: The three-dimensional score array s can be written as a sum of arrays of votes, one from each occupied cell 612a.

Proof:

First, it is noted that s is a function that maps elements in [symbol] ³ to real numbers (the detection scores at different window locations), that is s: [symbol] ³→ [symbol] . With this view in mind, combining Equation 5, with the previous definition of the vote v_{ϕ,ψ}f_{ϕ}·w_{ϕ-ψ}, Equation 8 is obtained:

$${s}_{ψ} = {\sum }_{φ ∈ {Φ}^{*}} {v}_{φ , ψ} \qquad Eq . ( 8 )$$

Now, v is defined for each ϕ,ψ∈ [symbol] ³. Given a fixed ϕ, with some abuse of notations, a function v_{ϕ}: [symbol] ³→ [symbol] is defined such that v_{ϕ}(ψ)=v_{ϕ,ψ}∀ψ∈ [symbol] ³. It is now obvious that the three-dimensional score array s can be written as:

$$s = {\sum }_{φ ∈ {Φ}^{*}} {v}_{φ} \qquad Eq . ( 9 )$$

The structure of the 3D array v_{ϕ} is then considered. By definition, v_{ϕ}(ψ)=v_{ϕ,ψ}=f_{ϕ}·w_{ϕ-ψ}, this implies that v_{ϕ}(ψ)=0 whenever ϕ−ψ∉Θ. Noting that ϕ specifies the “ID” of the occupied cell 612a from which the votes originate, and the window location a vote is being cast to, this means that only windows 632 at locations satisfying ϕ−ψ∈Θ can receive a non-zero vote from the cell 612a.

Now, given a fixed ϕ, the set Λ_{ϕ}={ψ∈ [symbol] ³:ϕ−ψ∈Θ}={ψ∈ [symbol] ³:∃θ∈Θ,ψ=ϕ−θ} is defined. Then the argument above limits the votes from cell ϕ to the subset of window locations given by Λ_{ϕ}. Window locations are given in terms of the coordinates of the origin 602 of each window. Λ_{ϕ} includes the origins of all windows which could receive a non-zero vote from the cell location ϕ, ie all windows which include the cell location ϕ.

Referring to FIG. 3b, the grey sphere 610 in the figure represents the location of the occupied cell ϕ and cubes 612 indicate window origin locations that will receive votes from ϕ, that is, the set Λ_{ϕ}.

FIGS. 7a and 7b therefore provide an illustration of the duality between convolution and voting. The location of the detection window 632 shown in FIG. 7a happens to include only three occupied cells 612a (represented by the three grey spheres). The origin 602 (anchor point) of the detection window 632 is highlighted by the larger grey cube at the corner of the detection window 632. The origin 702 happens to coincide with the cell location φ=ϕ=(i, j, k) on the feature grid 630. Being the origin 702 of the detection window 632, the anchor point 702 has coordinates θ=(0, 0, 0) on the detection window 632.

The feature vector 134 for the occupied cell 712a at grid location ϕ=(i+7, j+3, k) is shown as an illustration. The weights from the linear classifier are dense, and four-dimensional. The weight vector for an example location ϕ=(2, 3, 0) is highlighted by a small grey cube 704. All three occupied cells 612a cast votes to the window location φ, contributing to the score s_{φ}.

FIG. 7b shows an illustration of the votes that a single occupied cell 612a casts. The location of the occupied cell 612a is indicated by the grey sphere 610 and the origins 602 of detection windows 632 that receive votes from the occupied cell 712a are represented by grey cubes 712. This example is for an 8×4×3 window.

With the insight of the structure of voting gained, Corollary 1 readily translates into an efficient method: see Table A, below—to compute the array of detection scores s by voting.

TABLE A
Method 1

| | |
|---|---|
| 1 | Function Compute Score Array (w, f) |
| | Input: Weights of the classifier w and the feature grid f. |
| | Output: The array of detection scores s. |
| 2 | // Initialise the score array with zero values. |
| 3 | for ψ ϵ Ψ do |
| 4 | s_{ψ} ← 0; |
| 5 | end |
| 6 | // Begin voting. |
| 7 | for ϕ ϵ Φ* do |
| 8 | for θ ϵ Θ do |
| 9 | s_{ϕ-Φ} ← s_{ϕ-Φ} + f_{ϕ} · w_{θ}; |
| 10 | end |
| 11 | end |
| 12 | return s; |
| 13 | end |

The new set of indices Ψ⊂ [symbol] ³ introduced in Method 1 is the set of window locations that possibly receive a non-zero score, that is, Ψ=[1−Nₓ^{W},Nₓ^{G})×[1−N_{y}^{W},N_{y}^{G})×[1−N_{z}^{W},N_{z}^{G}). The main calculation happens inside the double loop where the dot product f_{ϕ}·w_{θ}, is computed for all ϕ∈Φ* and θ∈Θ. This, in fact, can be thought of as a single matrix-to-matrix multiplication as follows. First, all the feature vectors 134 for the occupied cells 612a are stacked horizontally to form a feature matrix F that is of size d×N, where d is the dimension of the feature vector per cell, and N is the total number of occupied cells.

Then, the weights of the classifier are arranged in a weight matrix W of size M×d, where M is the total number of cells 612 of the detection window 632. That is, each row of W corresponds to the transposition of some w_{θ} for some θ∈Θ. Now all the votes from all occupied cells 612a can be computed in one go as V=WF. The M×N votes matrix V then contains for each column the votes going to the window locations Λ_{ϕ} for some occupied cell ϕ∈Φ*.

However, despite the elegance of embodiments providing the method by computing all of the votes, the skilled person will understand that, in practice, other embodiments may compute individual columns of V as vᵢ=Wfᵢ. Using the notation, where vᵢ denotes the i'th column of V and similarly fᵢ the i'th column of F. These votes can then be added to the score matrix at each iteration in a batch. The reason that embodiments that calculate the individual columns of V may be advantageous is that the size of the entire matrix V is M×N, that is, the total number of cells 612 in the detection window 632 (which can be in the order of a thousand) by the number of all occupied cells 612a in the entire feature grid 630 (a fraction of the total number of cells in the feature grid). In most practical cases with presently available and affordable computational resources, V is too large to be stored in memory. The skilled person will understand that, as computational technology advances, memory storage may cease to be an issue and V may advantageously be calculated directly.

Corollary 2 verifies that sliding window detection with a linear classifier is equivalent to convolution.

Corollary 2—for some \tilde{w} related to w:

$${s}_{ψ} = {\sum }_{φ ∈ {ℤ}^{3}} {\tilde{w}}_{ψ - φ} \cdot {f}_{φ} \qquad Eq . ( 10 )$$

Proof: Looking at Equation 3, a reversed array of weights \tilde{w} may be defined by setting \tilde{w}_{θ}=w_{-θ} for all θ∈ [symbol] ³. Equation 10 then follows from Equation 3.

The convolution and/or subsequent processing by a ReLU can be repeated and stacked as in a traditional CNN 136.

As noted above, the embodiment being described is trained to recognise three classes of object: pedestrians; cars; and cyclists. As such, three separate networks 136a-c are trained—one for each class of object being detected. These three networks can be run in parallel and advantageously, as described below, each can have a differently sized receptive field specialised for detecting one of the classes of objects.

Other embodiments may arrange the network in a different manner. For example, some embodiment may be arranged to detect object of multiple classes with a single network instead of several networks.

Other embodiments may train more networks, or fewer networks.

The embodiment being described contains three network layers which are used to predict the confidence scores in the output data layer 200 that indicate the confidence in the presence of an object (which are output as per step 818); ie to provide a confidence score as to whether an object exists within the cells of the n-dimensional grid data input to the network. The first network layer processes an input data layer 401, and the subsequent network layers process intermediate data layers 400, 402. The embodiment being described contains an output layer 200 which holds the final confidence scores that indicate the confidence in the presence of an object (which are output as per step 818), an input layer (401) and intermediate data layers (400, 402). Although in the embodiment shown the networks 136 contains three network layers, other embodiments may contain any other number of network layers and for example, other embodiment may contain 2, 3, 5, 6, 7, 8, 10, 15, or more layers.

The skilled person will appreciate that the input feature vectors 134 are input to the input layer 401 of the network, which input layer 401 may be thought of as a data-layer of the network. The intermediate data layers 400, 402 and the output layer 200 may also be referred to as data layers. In the embodiment being described, convolution/voting is used in the network layers to move data into anyone of the four layers being described and the weights wₙ 308 are applied as the data is moved between data layers where the weights 308 may be thought of as convolution layers.

To handle objects at different orientations, the networks 136 are run over the discretised 3D grid generated from the raw point cloud 132 at a plurality of different angular orientations. Typically, each orientation may be handled in a parallel thread. This allows objects with arbitrary pose to be handled at a minimal increase in computation time, since a number of orientations are being processed in parallel.

For example, the discretised 3D grid may be rotated in steps of substantially 10 degrees and processed at each step. In such an embodiment, 36 parallel threads might be generated. In other embodiments, the discretised 3D grid may be rotated by other amounts and may for example be rotated by substantially any of the following: 2.5°, 5°, 7.5°, 12.5°, 15°, 20°, 30°, or the like.

In the embodiment being described, duplicate detections are pruned with non-maximum suppression (NMS) in 3D space. An advantage of embodiments using NMS is that NMS in 3D has been found better able to handle objects that are behind each other as the 3D bounding boxes overlap less than their projections into 2D.

The basis of the voting scheme applied by the embodiment being described is the idea of letting each non-zero input feature vector 134 cast a set of votes, weighted by filter weights 306 within units of the networks 136, to its surrounding cells in the output layer 200, as defined by the receptive field of the filter. Here, some in the art may refer to the units of the networks 136 as neurons within the network 136. This voting/convolution, using the weights, moves the data between layers (401, 402, 404, 200) of the network 136 (step 810).

The weights 308 used for voting are obtained by flipping the convolutional filter kernel 306 along each spatial dimension. The final convolution result is then simply obtained by accumulating the votes falling into each cell of the output layer (FIG. 3).

This process may be thought of as a ‘feature centric voting scheme’ since votes (that is a simply product of the weights and each non-zero feature vector) are cast and summed to obtain a value. The feature vectors are generated by features identified within the point cloud data 132 and as such, the voting may be thought of as being centred around features identified within the initial point-cloud. The skilled person will appreciate that here, and in the embodiment being described, a feature may be thought of as meaning non-zero elements of the data generated from the point-cloud where the non-zero data represent objects in the locale around the vehicle 102 that caused a return of signal to the LiDAR. As discussed elsewhere, data within the point cloud is largely sparse.

In brief, the left most block of FIG. 3 represents some, simplified, input data 132 within an input grid 300 with one of the cells 302 having a value 1 as the feature vector 134 and another of the cells 304 have a feature vector of value 0.5. It will be seen that the remaining 23 cells of the 25 cell input grid 300 contain no data and as such, the data can be considered sparse; ie only some of the cells contain data.

The central, slightly smaller, grids 306, 308 of FIG. 3 represent the weights that are used to manipulate the input feature vectors 134a, 134b. The grid 306 contains the convolutional weights and the grid 308 contains the voting weights. It will be seen that the voting weights 308 correspond to the convolutional weights 306, but have been flipped in both the X and Y dimensions. The skilled person will appreciate that if higher order dimensions are being processed then flipping will also occur in the higher order dimensions.

In the embodiment being described, the convolutional weights 306 (and therefore the voting weights 308) are learned from training data during a training phase. In other embodiments, the convolutional weights 306 may be loaded into the networks 136, may be from a source external to the processing circuitry 112.

The voting weights 308 are then applied to the feature vectors 134 representing the input data 132. The feature vector 134a, having a value of 1, causes a replication (ie a 1× multiplier) of the voting weight grid 308 centred upon cell 310. The feature vector 134b, having a value of 0.5, causes a 0.5 multiplier of the voting weight grid 308 centred upon cell 312. These two replications are shown in the results grid 314 and it can be seen that the cells of the results grid contain the sums of the two replications.

This procedure, described in relation to FIG. 3, can be formally stated as follows. Without loss of generality, assume we have a 3D convolutional filter with odd-valued side lengths, operating on a single input feature, with weights denoted by w∈ [symbol] ^{(2I+1)×(2J+1)×(2K+1)}. Then, for an input grid w∈ [symbol] ^{L×M×N}, the convolution result at location (l, m, n) is given by:

$${z}_{l , m , n} = {\sum }_{i = - I}^{I} {\sum }_{j = - J}^{J} {\sum }_{k = - K}^{K} {ω}_{i , j , k} {x}_{l + i , m + j , n + k} + b \qquad ( 11 )$$

where b is a bias value applied to all cells in the grid. This operation needs to be applied to all L×M×N locations in the input grid for a regular dense convolution. In contrast to this, given the set of cell indices for all of the non-zero cells

Φ={(l,m,n)∀x_{l,m,n}≠0},

the convolution can be recast as a feature-centric voting operation, with each input cell casting votes to increment the values in neighbouring cell locations according to:

z_{l+i,m+j,n+k}=z_{l+i,m+j,n+k}+ω_{-i,-j,-k}x_{l,m,n} (12)

which is repeated for all tuples (l,m,n)∈Φ′ and where i,j,k∈ [symbol] ∀[−I,I],[−J,J],[−K,K].

The voting output is passed through (step 814) a ReLU 138 (Rectified Linear Unit) nonlinearity which discards non-positive features as described in the next section. As such, the skilled person will appreciate that the ReLU 138 does not change the data shown in FIG. 3 since all values are positive. Other embodiments may use other non-linearities but ReLu's are believed advantageous since they help to reinforce sparsity within the data. The biases are constrained to be non-positive as a single positive bias would return an output grid in which every cell is occupied with a non-zero feature vector 134, hence eliminating sparsity. The bias term b therefore only needs to be added to each non-empty output cell.

With the sparse voting scheme described in relation to this embodiment, the filter only needs to be applied to the occupied cells in the input grid, rather than convolved over the entire grid. The full algorithm is described in more detail in D. Z. Wang and I. Posner, “Voting for Voting in Online Point Cloud Object Detection,” Robotics Science and Systems, 2015 including formal proof that feature-centric voting is equivalent to an exhaustive convolution. This reference is incorporated by reference, particularly in relation to the formal proof, and the skilled person is directed to read this paper and formal proof.

Thus, FIG. 4 illustrates that the input is a sparse discretised 3D grid, generated from the point-cloud 132 and each spatial location holds a feature vector 302 (ie the smallest shown cube within the input layer 401). The sparse convolutions with the filter weights w are performed natively in 3D, each returning a new sparse 3D representation. This is repeated several times to compute the intermediate representations (400,402) and finally the output 200.

Thus, in the embodiment being described, as data is moved into a layer of the neural network sparse convolutions is performed to move the data into that layer and this includes moving the data into the input layer 401 as well as between layers.

When stacking multiple sparse 3D convolution layers to build a deep neural network (eg convolution layers as shown in FIG. 4), it is desirable to maintain sparsity in the intermediate representations. With additional convolutional layers, however, the receptive field (404,406) of the network grows with each layer. This means that an increasing number of cells receive votes which progressively decreases sparsity higher up in the feature hierarchy. A simple way to counteract this behaviour, as used in the embodiment being described, is to follow a sparse convolution layer by a rectified linear unit (ReLU) 138 as advocated in X. Glorot, A. Bordes, and Y. Bengio, “Deep Sparse Rectifier Neural Networks,” AISTATS, vol. 15, pp. 315-323, 2011, which can be written as:

h=max (0,x) (13)

with x being the input to the ReLU nonlinearity and y being the output (step 814). The ReLU's are not shown in FIG. 4.

In the embodiment being described, only features within any one layer, that have a value greater than zero will be allowed to cast votes in the next sparse convolution layer. In addition to enabling a network to learn nonlinear function approximations, ReLUs may be thought of as performing a thresholding operation by discarding negative feature values which helps to maintain sparsity in the intermediate representations. Lastly, another advantage of ReLUs compared to other nonlinearities is that they are fast to compute.

The embodiment being described, uses the premise that a bounding box in 3D space should be similar in size for object instances of the same class. For example, a bounding box for a car will be a similar size for each car that is located. Thus, in the embodiment being described assumes a fixed-size bounding box for each class, and therefor for each of the three networks 136a-c. The resulting bounding box is then used for exhaustive sliding window detection with fully convolutional networks.

A set of fixed 3D bounding box dimensions is selected for each class, based on the 95th percentile ground truth bounding box size over the training set. In the embodiment being described, the receptive field of a network (the portion of the input space that contributes to each output score) should be at least as large as this bounding box, but not excessively large as to waste computation.

In the embodiment being described, a first bounding box was chosen to relate to pedestrians; a second bounding box was chosen to relate to cyclists; and a third bounding box was chosen to relate to cars. Other sizes may also be relevant, such as lorries, vans, buses or the like.

Fixed-size bounding boxes imply that networks can be straightforwardly trained on 3D crops of positive and negative examples whose dimensions equal the receptive field size of a network. The skilled person will appreciate that here, ‘crops’ means taking a portion of the training data. In this embodiment, portions of training data (ie crops) are used to create both positive and negative examples of a class (eg cars, pedestrians, bikes) in order to train the network.

In the described embodiment, the initial set of positive training crops consist of front-facing examples, but the bounding boxes for most classes are orientation dependent. While processing point clouds 132 at several angular rotations allows embodiments to handle objects with different poses to some degree, some embodiments may further augment the positive training examples by randomly rotating a crop by an angle. Here the crops taken from the training data may be rotated by substantially the same amount as the discretised grid, as is the case in the embodiment being described; ie 10° intervals. However, in other embodiments the crops may be rotated by other amounts such as listed above in relation to the rotation of the 3D discretised grid.

Similarly, at least some embodiments also augment the training data by randomly translating the crops by a distance smaller than the 3D grid cells to account for discretisation effects.

Both rotation and translation of the crops is advantageous in that it increases the amount of training examples that are available to train the neural network. Thus, there is advantage in performing only one of the cropping and/or rotation as well as in performing both.

Negatives may be obtained by performing hard negative mining periodically, after a fixed number of training epochs. Here, there skilled person will appreciate that a hard negative is an instance which is wrongly classified by the neural network as the object class of interest, with high confidence. Ie. it is actually a negative, but it is hard to get correct. For example, something that has a shape that is similar to an object within the class (eg a pedestrian may be the class of interest and a postbox may be a similar shape thereto). Such hard negatives may be difficult classify and therefore, it is advantageous to mine the training data for such examples so that the neural network can be trained on those examples.

Each of the three class specific networks 136a-c is a binary classifier and it is therefore appropriate to use a linear hinge loss for training due to its maximum margin property. In the embodiment being described, the hinge loss, [symbol] ₂ weight decay and an [symbol] ₁ sparsity penalty are used to train the networks with stochastic gradient descent. Both the [symbol] ₂ weight decay as well as the [symbol] ₁ sparsity penalty serve as regularisers. An advantage of the sparsity penalty is that it also, like selection of the ReLU, encourages the network to learn sparse intermediate representations which reduces the computation cost.

In other embodiments, other penalties may be used such as for example as the general Lp norm, or a penalty based on other measures (eg. The KL divergence).

Given an output detection score x₀ and a class label y∈{−1, 1} distinguishing between positive and negative samples, the hinge loss is formulated as:

L(θ)=max(0, 1−x₀·y) (14)

here θ denotes the parameters of the network 136a-c.

The loss in Eq. 4 is zero for positive samples that score over 1 and negative samples that score below −1. As such, the hinge loss drives sample scores away from the margin given by the interval [−1, 1]. As with standard convolutional neural networks, the [symbol] ₁ hinge loss can be back-propagated through the network to compute the gradients with respect to the weights 306, 308.

The ability to perform fast voting is predicated on the assumption of sparsity in the input to each layer 400, 402 of the networks 136a-c. While the input point cloud 132 is sparse, the regions of non-zero cells are dilated in each successive layer 400, 402, approximately by the receptive field size of the corresponding convolutional filters. It is therefore prudent to encourage sparsity in each layer, such that the model only utilises features if they are relevant for the detection task.

The [symbol] ₁ loss has been shown to result in sparse representations in which several values are exactly zero K. P. Murphy, Machine Learning: A Probabilistic Perspective. MIT press, 2012. Whereas the sparsity of the output layer 200 can be tuned with a detection threshold, embodiments encourage sparsity in the intermediate layers by incorporating a penalty term using the [symbol] ₁ norm of each feature activation.

Embodiments were trialled on the well-known KITTI Vision Benchmark Suite [A. Geiger, P. Lenz, and R. Urtasun, “Are we ready for autonomous driving? the KITTI vision benchmark suite,” in Proceedings of the IEEE Computer Society Conference on Computer Vision and Pattern Recognition, 2012, pp. 3354-3361] for training and evaluating the detection models. The dataset consists of synchronised stereo camera and lidar frames recorded from a moving vehicle with annotations for eight different object classes, showing a wide variety of road scenes with different appearances. It will be appreciated that the embodiment being described, only three of these classes were used (Pedestrians; Cycles; and Cars).

Embodiments use the 3D point cloud data for training and testing the models. There are 7,518 frames in the KITTI test set whose labels are not publicly available. The labelled training data consists of 7,481 frames which were split into two sets for training and validation (80% and 20% respectively). The object detection benchmark considers three classes for evaluation: cars, pedestrians and cyclists with 28,742; 4,487; and 1,627 training labels, respectively.

As described above, the three networks 136a-c are trained on 3D crops of positive and negative examples; each network is trained with examples from the relevant classes of objects. The number of positives and negatives is initially balanced with negatives being extracted randomly from the training data at locations that do not overlap with any of the positives. Hard negative mining was performed every ten epochs by running the current model across the full point clouds in the training set. In each round of hard negative mining, the ten highest scoring false positives per point cloud frame are added to the training set.

The weights 306, 308 are initialised as described in K. He, X. Zhang, S. Ren, and J. Sun, “Delving Deep into Rectifiers: Surpassing Human-Level Performance on ImageNet Classification,” arXiv preprint arXiv:1502.01852, pp. 1-11, 2015. [Online]. Available: https://arxiv.org/abs/1502.01852 and trained with stochastic gradient descent with momentum of 0.9 and [symbol] ₂ weight decay of 10⁻⁴ for 100 epochs with a batch size of 16. The model from the epoch with the best average precision on the validation set is selected for the model comparison and the KITTI test submission in Sections V-E and V-F, respectively.

Some embodiments implement a custom C++ library for training and testing. For the largest models, training may take about three days on a cluster CPU node with 16 cores where each example in a batch is processed in a separate thread.

A range of fully convolutional architectures with up to three layers and different filter configurations is explored as shown in Table I in FIG. 4. To exploit context around an object, the architectures are designed so that the total receptive field is slightly larger than the class-specific bounding boxes. Small 3×3×3 and 5×5×5 kernels are used in the lower layers and each layer is followed by a ReLU 138 nonlinearity. The network 136a-c outputs are computed by an output data layer 200, which in the embodiment being described, is a linear layer implemented as a convolutional filter whose kernel size gives the desired receptive field for the network for a given class of object.

The official benchmark evaluation on the KITTI test server is performed in 2D image space. In the training that was performed, embodiments were therefore arranged to project 3D detections into a 2D image plane using the provided calibration files and discard any detections that fall outside of the image. The KITTI benchmark differentiates between easy, moderate and hard test categories depending on the bounding box size, object truncation and occlusion. An average precision score is independently reported for each difficulty level and class. The easy test examples are a subset of the moderate examples, which are in return a subset of the hard test examples. The official KITTI rankings are based on the performance on the moderate cases. Results are obtained for a variety of models on the validation set, and selected models for each class are submitted to the KITTI test server.

Fast run times are particularly important in the context of mobile robotics, and particularly in the field of self-driving vehicles where ‘real-time’ operation and fast reactions times are relevant for safety. Larger, more expressive models, having more layers, more filters, or the like, within the networks, etc. come at a higher computational cost, work was performed to investigate the trade-off between detection performance and model capacity. Five architectures were benchmarked against each other with up to three layers and different numbers of filters in the hidden layers (FIGS. 5a and 5b). These models were trained without the [symbol] ₁ penalty which is discussed below.

The nonlinear, multi-layer networks clearly outperform the linear baseline, which is comparable to results shown by the embodiments of D. Z. Wang and I. Posner, “Voting for Voting in Online Point Cloud Object Detection,” Robotics Science and Systems, 2015. The applicant believes that this demonstrates that increasing the complexity and expressiveness of the models is helpful for detecting objects in point clouds.

Even though performance improves with the number of convolutional filters in the hidden layers, the resulting gains are comparatively moderate. Similarly, increasing the receptive field of the filter kernels does not improve the performance. It is possible that these larger models are not sufficiently regularised. Another potential explanation is that the easy interpretability of 3D data enables even these relatively small models to capture most of the variation in the input representation which is useful for solving the task.

From Table I as shown in FIG. 4, the ‘B’ model was selected for cars, and the ‘D’ model was selected for pedestrians and cyclists, with 8 filters per hidden layer for evaluation on the KITTI test set. These models are selected for their high performance at a relatively small number of parameters. The performance of the embodiment being described is compared against the other leading approaches for object detection in point clouds (at the time of writing) in Table II

TABLE II
AVERAGE PRECISION IN % ON THE KITTI TEST DATSET FOR METHODS ONLY USING
POINT CLOUDS. Vote3Deep OUTPERFORMS ALL OTHER METHODS BY A CONSIDERABLE
MARGIN AND STILL RUNS AT A COMPETITIVE SPEED ON A CPU.

| | | | | Cars | | | Pedestrians | | | Cyclists | | |
|---|---|---|---|---|---|---|---|---|---|---|---|---|
| | | Processor | Speed | Easy | Moderate | Hard | Easy | Moderate | Hard | Easy | Moderate | Hard |
| Vote3Deep | 4- | 2.5 GHz | 1.5 s | 76.79 | 68.24 | 63.23 | 68.39 | 55.37 | 52.59 | 79.92 | 67.88 | 62.98 |
| | cone | CPU | | | | | | | | | | |
| Vote3D | 4- | 2.8 GHz | 0.5 s | 56.80 | 47.99 | 42.56 | 44.48 | 35.74 | 33.72 | 41.43 | 31.24 | 28.60 |
| [5] | cone | CPU | | | | | | | | | | |
| VeloFCN | | 2.5 GHz | 1.0 s | 60.34 | 47.51 | 42.74 | — | — | — | — | — | — |
| [7] | | CPU | | | | | | | | | | |
| CScR | 4- | 2.5 GHz | 3.5 s | 34.79 | 26.13 | 22.69 | — | — | — | — | — | — |
| | cone | CPU | | | | | | | | | | |
| mBoW | 1- | 2.5 GHz | 10 s | 36.02 | 23.76 | 18.44 | 44.28 | 31.37 | 30.62 | 28.00 | 23.62 | 20.93 |
| [19] | cone | CPU | | | | | | | | | | |

The embodiment being described establishes new state-of-the-art performance in this category for all three classes and all three difficulty levels. The performance boost is particularly significant for cyclists with a margin of almost 40% on the easy test case, in some cases more than doubling the average precision. Compared to the very deep networks commonly used in image-based vision, such as described in:
K. Simonyan and A. Zisserman, “Very deep convolutional networks for large-scale image recognition,” ICLR, pp. 1-14, 2015. [Online]. Available: http://arxiv.org/abs/1409.155;
C. Szegedy, W. Liu, Y. Jia, P. Sermanet, S. Reed, D. Anguelov, D. Erhan, V. Vanhoucke, and A. Rabinovich, “Going deeper with con¬volutions,” in Proceedings of the IEEE Computer Society Conference on Computer Vision and Pattern Recognition, vol. 07-12-June, 2015, pp. 1-9; and
K. He, X. Zhang, S. Ren, and J. Sun, “Deep Residual Learning for Image Recognition,” arXiv preprint arXiv:1512.03385, vol. 7, no. 3, pp. 171-180, 2015. [Online]. Available: http://arxiv.org/pdf/1512.03385v1.pdf
   these relatively shallow and unoptimised networks are expressive enough to achieve significant performance gains. The embodiment being described currently runs on a CPU and is about three times slower than the embodiment being described in D. Z. Wang and I. Posner, “Voting for Voting in Online Point Cloud Object Detection,” Robotics Science and Systems, 2015. and 1.5 times slower than the embodiment described in B. Li, T. Zhang, and T. Xia, “Vehicle Detection from 3D Lidar Using Fully Convolutional Network,” arXiv preprint arXiv:1608.07916, 2016. [Online]. Available: https://arxiv.org/abs/1608.07916 with the latter relying on GPU acceleration. It is expected that a GPU (Graphics Processing Unit) implementation of the embodiment being described will further improve the detection speed.

The embodiment being described was also compared against methods that utilise both point cloud and image data in Table III.

TABLE III
AVERAGE PRECISION IN % ON THE KITTI TEST DATSET FOR METHODS WITH BOTH POINT
CLOUDS AND IMAGES, INDICATED BY *. DESPITE ONLY UTILIZING POINT CLOUDS,
Vote3Deep STILL OUTPERFORMS BOTH OF THESE APPROACHES IN THE MAJORITY OF
TEST CASES. IN PARTICULAR, Vote3Deep ACHIEVES THE BEST PERFORMANCE ON ALL
HARD TEST CASES, WHICH CONTAIN THE LARGEST NUMBER OF EXAMPLES

| | | | | Cars | | | Pedestrians | | | Cyclists | | |
|---|---|---|---|---|---|---|---|---|---|---|---|---|
| | | Processor | Speed | Easy | Moderate | Hard | Easy | Moderate | Hard | Easy | Moderate | Hard |
| Vote3Deep | 4- | 2.5 GHz | 1.5 s | 76.79 | 68.24 | 63.23 | 68.39 | 55.37 | 52.59 | 79.92 | 67.88 | 62.98 |
| | cone | CPU | | | | | | | | | | |
| MV-RGBD- | 4- | 2.5 GHz | 4 s | 76.40 | 69.92 | 57.47 | 73.30 | 56.59 | 49.63 | 52.97 | 42.63 | 37.43 |
| RF* [20] | cone | CPU | | | | | | | | | | |
| Fusion- | 1- | 3.5 GHz | 30 s | — | — | — | 59.51 | 46.67 | 42.05 | — | — | — |
| DPM* [21] | cone | CPU | | | | | | | | | | |

FIG. 5 a shows a model comparison for the architecture in Table I (as seen in FIG. 4). It can be seen that the nonlinear models with two or three layers consistently outperform the linear baseline model our internal validation set by a considerable margin for all three classes. The performance continues to improve as the number of filters in the hidden layers is increased, but these gains are incremental compared to the large margin between the linear baseline and the smallest multi-layer models.

Reference to RF in Table I relates to the Receptive Field for the last layer that yields the desired window size of the object class. The skilled person will appreciate that ‘Receptive Field’ in general is a term of art that refers to the filter size (ie the size and shape of the convolutional/voting weights) for a given layer.

Despite only using point cloud data, the embodiment being described still performs better than these (A. Gonzalez, G. Villalonga, J. Xu, D. Vazquez, J. Amores, and A. M. Lopez, “Multiview random forest of local experts combining RGB and LIDAR data for pedestrian detection,” in IEEE Intelligent Vehicles Symposium, Proceedings, vol. 2015-Augus, 2015, pp. 356-361; and C. Premebida, J. Carreira, J. Batista, and U. Nunes, “Pedestrian dete¬ction combining RGB and dense LIDAR data,” in IEEE International Conference on Intelligent Robots and Systems, 2014, pp. 4112-4117) in the majority of test cases and only slightly worse in the remaining ones at a considerably faster detection speed. For all three classes, the embodiment being described achieves the highest average precision on the hard test cases, which contain the largest number of object labels.

The PR (Precision vs. Recall) curves for the embodiment being described on the KITTI test set are shown in FIG. 5b (a) shows cars; b) shows pedestrians; and c) shows cyclists). Here, the skilled person will appreciate that recall is the fraction of the instances of the object class that are correctly identified, and may be thought of a measurement of sensitivity. Precision is the fraction of the instances classified as positive that are in fact correctly classified, and may be thought of as a quality measure.

It will be noted that cyclist detection benefits the most from the expressiveness of the network 136 even though this class has the least number of training examples; it will be noted that the curves for the cyclists extend closer to the top right of FIG. 5b(c) indicating a higher precision and a higher recall. Also, it can be seen that the average precision (FIG. 5a(c)) is higher for the cyclists; ie the lines are further from the baseline. The applicant believes that cyclists are more distinctive in 3D than pedestrians and cars due to their unique shape which is particularly well discriminated despite the small amount of training data.

During development, the three networks 136 were also trained with different values for the [symbol] ₁ sparsity penalty to examine the effect of the penalty on run-time speed and performance (Table IV above). It was found that larger penalties than those presented in the table tended to push all the activations to zero. The networks were all trained for 100 epochs and the final networks are used for evaluation in order to enable a fair comparison. It was found that selecting the models from the epoch with the largest average precision on the validation set tends to favour models with a comparatively low sparsity in the intermediate representations. The mean and standard deviation of the detection time per frame were measured on 100 frames from the KITTI validation set.

It was found that pedestrians have the fastest detection time and this is likely to be because the receptive field of the networks is smaller compared to the other two classes (cars and cyclists). The two-layer ‘B’ architecture is used for cars during testing, as opposed to the three-layer ‘D’ architecture for the other two classes, which explains why the corresponding detector runs faster than the three-layer cyclist detector even though cars require a larger receptive field than cyclists.

It was found that the sparsity penalty improved the run-time speed by about 12% and about 6% for cars and cyclists, respectively, at a negligible difference in average precision. For pedestrians, it was found that without the sparsity penalty ran slower and performed better than the baseline. Notably, the benefit of the sparsity penalty increases with the receptive field size of the network. The applicant believes that pedestrians are too small to learn representations with a significantly higher sparsity through the sparsity penalty, and that the drop in performance for the baseline model is a consequence of the selection process used for the network.

1. A method of detecting objects within a three dimensional environment, the method comprising using a neural network to process data representing that three dimensional environment and arranging the neural network to have at least one layer containing a set of units having an input thereto and an output therefrom, inputting data representing the environment as and n-dimensional grid comprising a plurality of cells;
arranging the set of units within the layer to output result data to a further layer arranging the set of units within the layer to perform a convolution operation on the input data;
arranging the convolution operation such that it is implemented using a feature centric voting scheme applied only to the non-zero cells in the input to the layer; and
wherein the output from the neural network provides a confidence score as to whether an object exists within the cells of the n-dimensional grid.

2. A method according to claim 1 in which input data is held in a format in which data representing empty space is not stored.

3. A method according to claim 1 in which a network is trained to recognise a single class of object.

4. A method according to claim 3 in which a plurality of networks are trained, each arranged to detect a class of object.

5. A method according to claim 1 in which data is input in parallel to the neural network.

6. A method according to claim 1 in which is arranged to maintain sparsity within intermediate representations handled by layers of the network.

7. A method according to claim 6 which uses Rectified Linear Units.

8. A method according to claim 6 which uses non-maximal suppression.

9. A method according to claim 1 in which weights used in the feature centric voting scheme are obtained by flipping convolutional filter kernel along each spatial dimension.

10. A vehicle provided with processing circuitry, wherein the processing circuitry is arranged to provide a neural network comprising at least one layer containing a set of units having an input thereto and an output therefrom,
the input being arranged to have data input thereto representing an n-dimensional grid comprising a plurality of cells;
the set of units within the layer being arranged to output result data to a further layer the set of units within the layer being arranged to perform a convolution operation on the input data;
the convolution operation is implemented using a feature centric voting scheme applied only to the non-zero cells in the input to the layer; and
wherein the output from the neural network provides a confidence score as to whether an object exists within the cells of the n-dimensional grid.

11. A vehicle according to claim 10, which comprises a sensor arranged to generate input data which is input to the input of the neural network.

12. A vehicle according to claim 11 in which the sensor is a LiDAR sensor.

13. A neural network comprising at least one layer containing a set of units having an input thereto and an output therefrom,
the input being arranged to have data input thereto representing an n-dimensional grid comprising a plurality of cells;
the set of units within the layer being arranged to output result data to a further layer the set of units within the layer being arranged to perform a convolution operation on the input data;
the convolution operation is implemented using a feature centric voting scheme applied only to the non-zero cells in the input to the layer; and
wherein the output from the neural network provides a confidence score as to whether an object exists within the cells of the n-dimensional grid.

14. A neural network according to claim 13 comprising a plurality of layers of units.

15. A neural network according to claim 14 which comprises a layer of rectified linear units (ReLUs) arranged to receive the outputs of the neurons from at least some of the layers.

16. A neural network according to claim 14 which comprises an output layer of units, which output layer does not have a rectified linear unit applied to the result data thereof.

17. A neural network according to claim 13 which is a convolutional neural network.

18. A neural network according to claim 13 in which the n-dimensional grid is three dimensional (3D).

19. A neural network according to claim 13 wherein the first layer is an input layer arranged to receive data representing a 3D environment.

20. A machine readable medium containing instructions which when read by a machine, cause a circuitry of that machine to provide a neural network having at least one layer containing a set of units having an input thereto and an output therefrom,
the input being arranged to have data input thereto representing an n-dimensional grid comprising a plurality of cells;
the set of units within the layer being arranged to output result data to a further layer the set of units within the layer being arranged to perform a convolution operation on the input data; and
wherein the convolution operation is implemented using a feature centric voting scheme applied only to the non-zero cells in the input to the layer.
